(19) United States
(12) Patent Application Publication
(10) Pub. No.: US 2026/0184031 A1
(43) Pub. Date: Jul. 2, 2026

(54) SYSTEMS AND METHODS FOR INDICATING REMAINING BUILD MATERIAL FOR EXCAVATION AND/OR CLEANING OF PARTS GENERATED BY ADDITIVE MANUFACTURING

(71) Applicant: Mark Lamoncha, Columbiana, OH (US)

(72) Inventor: Mark Lamoncha, Columbiana, OH (US)

(21) Appl. No.: 19/438,823

(22) Filed: Jan. 2, 2026

Related U.S. Application Data
(60) Provisional application No. 63/741,155, filed on Jan. 2, 2025.
(60) Provisional application No. 63/742,676, filed on Jan. 7, 2025.

(51) Int. Cl. B29C 71/00; B29C 64/386; B33Y 40/00; B33Y 50/00; G06T 7/00

(52) U.S. Cl. CPC B29C 71/00; B29C 64/386; G06T 7/0004; B33Y 40/00; B33Y 50/00

(57) ABSTRACT

Systems and methods for indicating remaining build material for excavation and/or cleaning of parts generated by additive manufacturing are provided. Image data is received of part(s) generated by an additive manufacturing machine. The image data is analyzed to extract feature characteristics of the part(s). A determination is made, on a feature characteristic specific basis, if the extracted feature characteristics are within a predetermined margin of expected feature characteristics for the parts. Where one or more the extracted feature characteristics are not within the predetermined margin of the expected feature characteristics, corresponding areas are visually indicated as needing further cleaning/excavation.

### CROSS-REFERENCE TO RELATED APPLICATIONS

This application claims the benefit of U.S. provisional patent application Ser. No. 63/741,155 filed Jan. 2, 2025, as well as U.S. provisional patent application Ser. No. 63/742,676 filed Jan. 7, 2025, each of the foregoing being hereby incorporated by reference as if fully restated herein.

### TECHNICAL FIELD

Exemplary embodiments relate generally to systems and methods for indicating remaining build material (e.g., areas of loose sand and/or support material) for excavation and/or cleaning of parts generated by additive manufacturing (e.g., 3D printing).

### BACKGROUND AND SUMMARY OF THE INVENTION

Various forms of additive manufacturing are known. Additive manufacturing has many benefits including, without limitation, efficient production, ability to create complex geometries, and the like. A relatively common type of additive manufacturing is 3D printing. 3D printing is available in various forms, including but not limited to, binder jetting. Some forms of 3D printing, such as binder jetting, require that the printed parts be excavated and/or cleaned. In the example of binder jetting, build material (e.g., various types of powdered plastics or other substances; sometimes referred to generally as “sand”) is deposited in a build box. Typically, the build material is pretreated with a binding agent and a second agent, typically an activator for the binding agent, is sprayed on portions of the build material corresponding to the part(s) to be manufactured. The table is typically dropped and an additional layer of build material is deposited, such as by way of a recoater. The process is repeated to generate the part(s). Thereafter, the parts are excavated from the build box and/or cleaned, such as manually using various tools like brushes, pressurized air, shovels, picks, combinations thereof, or the like. Sometimes, multiple parts are printed in a same build box and must be removed. Typically, the build box is removed from the machine for excavation and/or cleaning, though such is not necessarily required.

This excavation and cleaning process is time and labor intensive. Furthermore, this excavation and cleaning process is typically performed by manual, visual interpretation by a technician of the build box (e.g., visually inspecting what the technician perceives to the part) and/or manual, visual comparison against one or more drawings of the part(s). The manual nature of the process is subject to error, and missteps can result in a part being damaged, sometimes irreparably, or insufficiently prepared for further use.

Systems and methods for indicating remaining build material (e.g., areas of loose sand and/or support material) for excavation and/or cleaning of 3D printed parts are provided. Image data may be captured by external cameras and/or augmented reality (AR) devices of printed parts, such as at a build box after printing and/or in a partially or perceived to be fully excavated and/or cleaned state. Alternatively, or additionally, image data may be captured of the printed parts, such as at the build box after printing and/or in a partially or perceived to be fully excavated and/or cleaned state, by way of an X-ray machine.

The image data may be compared against 3D files for the part to determine if a sufficient match exists. If a sufficient match does not exist, areas of remaining build material, such as loose build sand and/or support material, may be highlighted at the AR devices and/or by way of projection devices at the build box for further excavation and/or cleaning. Once sufficiently matched, completion of the part(s) may be recorded and/or indicated, such as to the technician by way of the AR devices and/or projection devices. Alternatively, or additionally, such visual indications may be provided at one or more electronic displays, such as provided at the work area.

In exemplary embodiments, without limitation, such analysis may be made by way of machine vision software, which may optionally utilize one or more artificial intelligence (“AI”) models, such as but not limited to, neural networks. Features of the parts may be extracted and their characteristics (e.g., locations, sizes, and/or shapes) compared against expected feature characteristics, such as from the 3D files.

The AI model(s), in exemplary embodiments, are trained using image data (e.g., from camera images and/or X-ray images) identified as being associated with sufficiently excavated/cleaned and non-sufficiently excavated/cleaned parts and associated 3D files for such parts. Such image data may be manually tagged. The AI model(s) may optionally be updated over time, such as based on manually provided feedback regarding sufficiently and/or insufficiently excavated/cleaned parts. Such feedback may, for example and without limitation, be provided by technicians, supervisors, inventory control systems (e.g., based on customer rejections and/or returns), or the like. The AI model(s) may be configured to utilize such feedback data to adjust the AI model(s) over time. For example, feedback may be electronically provided by way of user devices (e.g., smartphones, computers, tablets, and the like) associated with such individuals. Image data associated with the feedback may be tagged in accordance with the feedback and provided to the AI model(s) for further training/retraining.

Alternatively, or additionally, an overlay of the printed parts and/or support material may be generated, such as at the AR device, by projected overlay, and/or at electronic display(s). In this way, the technician may manually identify areas for excavation (e.g., loose sand and/or support material), areas to avoid (e.g., part), and areas to be careful (e.g., as approach part and/or support material).

In exemplary embodiments, the part(s) of the build box may be matched with a corresponding part file, such as using the image data from the imaging devices. The corresponding part file data may thereafter be used to generate the overlay of the printed parts and/or support material at the AR device, by projected overlay, and/or at electronic display(s).

Further features and advantages of the systems and methods disclosed herein, as well as the structure and operation of various aspects of the present disclosure, are described in detail below with reference to the accompanying figures.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical, similar, or equivalent features, and wherein:

FIG. 1 is a plan view of an exemplary system for indicating remaining build material for excavation and/or cleaning of parts generated by additive manufacturing;

FIG. 2 is a flow chart with exemplary logic for operating the system of FIG. 1;

FIG. 3 is a plan view of another exemplary system for indicating remaining build material for excavation and/or cleaning of parts generated by additive manufacturing;

FIG. 4 is a flow chart with exemplary logic for operating the system of FIG. 3;

FIG. 5 is a plan view of an exemplary overlay output generated by the system and/or methods of FIGS. 1-4;

FIG. 6 is a plan view of another exemplary overlay output generated by the system and/or methods of FIGS. 1-4;

FIG. 7 is a flow chart with exemplary logic for operating the system of FIG. 3; and

FIG. 8 is a flow chart with exemplary logic for operating the system of FIG. 3.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

Embodiments of the invention are described herein with reference to illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

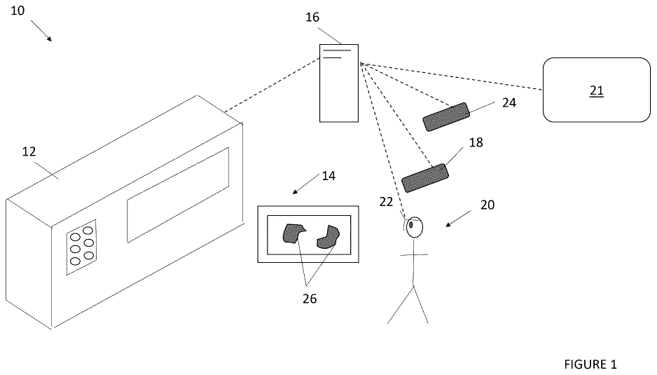

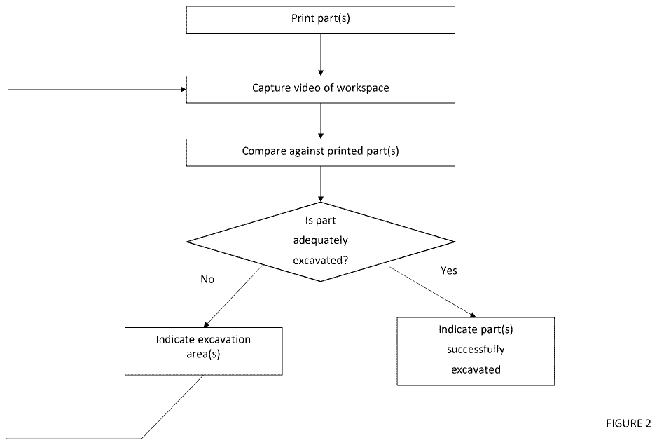

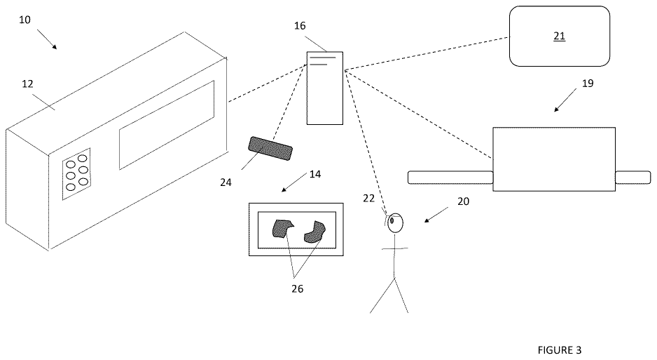

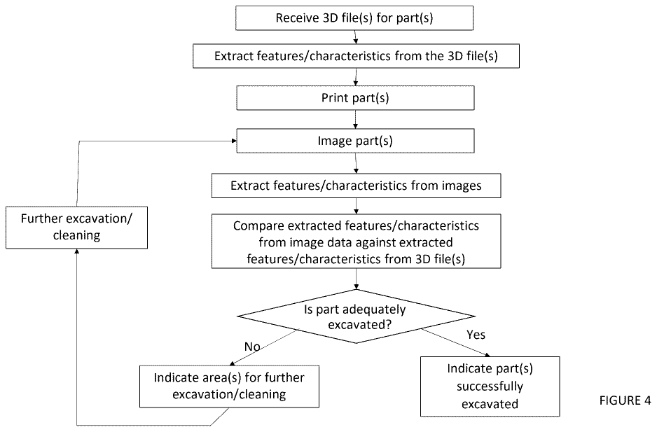

FIG. 1 and FIG. 3 illustrates exemplary systems 10 for indicating remaining build material for excavation and/or cleaning of parts 26 generated by additive manufacturing machines 12, such as 3D printing. FIG. 2 and FIG. 4 provide exemplary methods for operating the systems 10, or at least select components thereof.

Part(s) 26 are generated by an additive manufacturing machine 12 (“machine”), such as but not necessarily limited to a 3D printer, such as but not necessarily limited to a binder jetting device. Preferably, the machine 12 is one which utilizes sand or powder as the support material, though such is not necessarily required. For example, without limitation, the machine 12 may be one of various types and/or kinds of additive manufacturing machines 12 which utilized sand or powder beds.

The machine 12 may be configured to generate part(s) 26, such as at a build box 14. Preferably, but optionally, the build box 14 is removable, such as for cleaning/excavation and/or inspection and part 26 removal.

The manufactured parts 26 may be generated in accordance with 3D drawing data, such as uploaded to the machine 12 from one or more servers 16 and/or other remote electronic devices (e.g., smartphone, laptop, personal computer, tablet, combinations thereof, or the like). The machines 12 may be known additive manufacturing machines, such as but not limited to, those available from ExOne, and may operate, at least as to parts 26 manufacture, according to known techniques.

As illustrated with particular regard to FIGS. 1-2, a camera 18 at the associated workspace, preferably but optionally located outside of the machine 12, may capture images of the build box 14, such as after the parts 26 are generated and the build box 14 removed from the machine 12. A designated workspace area may be provided for capturing accurate images, such as an illuminated workbench or table area. In exemplary embodiments, the camera 18 is located to face downward onto the workbench or table area and additional lighting is provided adjacent to the camera 18 and oriented downward to face the workbench or table area. However, a variety of number and type of cameras 18 may be utilized, such as inside of and/or outside of the machine 12 and/or at various angles relative to the workspace and/or build box 14. Placing the camera(s) 18 outside of the machine may allow for more convenient excavation. Using multiple cameras 18 may allow more accurate data collection and excess build material identification. For example, without limitation, at least two offset cameras 18 may be utilized to capture depth information. The camera(s) 18 may be one or more known cameras and/or machine vision systems.

Alternatively, or additionally, images may be captured by an augmented reality (AR) device 22 worn by a technician 20, preferably the technician 20 performing the excavation and/or cleaning. The AR device 22 may include, for example without limitation, the HOLOLENS device available from Microsoft, the GLASS device available from Google, the VISION PRO device available from Apple, combinations thereof, or the like. Such AR devices 22 may comprise one or more embedded cameras for capturing such images, such as while the technician 20 is gazing at the build box 14.

As illustrated with particular regard to FIGS. 3-4, alternatively, or additionally, an X-ray machine 19 may be utilized to capture the images and/or image data. Advantageously, the use of an X-ray machine 19 may allow for at least limited penetration of remaining build material within a build box 14 for more accurate part(s) 26 imaging. The X-ray machine 19 may be one or more known X-ray machines 19, particularly but not exclusively, those utilized for industrial inspection. The X-ray machine 19 may optionally include or be associated with a conveyor for moving the build boxes 14 therethrough. The X-ray machine 19 may be sized to accommodate the same.

While the X-ray machine 19 is sometimes shown and/or described as being separate from the additive manufacturing machine 12, in other exemplary embodiments, the X-ray machine 19, or components thereof for providing the X-ray images and/or image data, may be provided within and/or as part of the additive manufacturing machine 12. This may be particularly advantageous, by way of example and without limitation, where the build box 14 is not otherwise removable.

The camera(s) 18, X-ray machine(s) 19, and/or AR devices 22 may herein be sometimes referred to generally as imaging devices.

Image data from the imaging devices (e.g., camera(s) 18, AR devices 22, and/or X-ray machines 19) may be transmitted to the same or different servers 16, such as by way of one or more wired and/or wireless connections. While server(s) 16 are sometimes shown and/or described, other computing devices may be utilized, such as personal computers, laptops, tablets, smartphones, combinations thereof, or the like.

The server(s) 16 may be configured to analyze the received image data, such as using one or more machine vision and/or artificial intelligence models (e.g., neural networks). For example, without limitation, the image data may be analyzed for various features and associated characteristics. Such features may include, by way of example and without limitation, part outlines, holes, protrusions, depressions, edges, surface texture, markings, combinations thereof, and the like. Such characteristics may include, by way of example and without limitation, sizes, locations, shapes, combinations thereof, and the like. Each of the parts may be associated with one or more features, and each of the features may be associated with one or more characteristics. Each of characteristics extracted from the image data of the part(s) 26 may be compared against expected characteristics. The comparison may be made on a part, feature, and characteristic specific basis. The expected characteristics and associated features may be specified in and/or extracted from the 3D print and/or part files for the part(s) 26. Such expected characteristics, features, and and/or part information may be supplied directly to the server(s) 16 by user devices and/or from the additive manufacturing machine 12, such as based on supplied information regarding part(s) 26 undergoing printing. The image data may be supplied to the server(s) 16 by the imaging devices.

The foregoing may be accomplished, at least in part, using feature extraction and/or machine vision techniques. In exemplary embodiments, without limitation, the server(s) 16 and/or AI model(s) are configured to compare the received image data, particularly the extracted features and characteristics thereof, against the 3D file data for the parts 26, such as to identify and compare the actual features and/or characteristics (e.g., size, shape, location) of the current excavation/cleaned parts 26 (from the image data) against corresponding expected features and/or characteristics (e.g., size, shape, location) (from the associated part 26 file(s)).

Where the server(s) 16 and/or AI model(s) determine that the feature characteristics of the current excavation/cleaned part(s) 26 (as determined from analysis of the image data) indicates that the part(s) 26 are outside of a predetermined margin (e.g., 5% or less, 1% or less, etc.) of the corresponding expected feature characteristic(s) (as determined from the part file), indication of one or more areas 28 where additional excavation and/or cleaning is required may be displayed at the AR device 22 and/or by way of the projection device(s) 24, and/or recorded, such as at the server(s) 16.

The predetermined margin(s) may be the same or different across parts 26 features, and/or characteristics thereof. Preferably, such indication and analysis is made on a feature by feature and characteristic by characteristic basis, however, a collective margin for multiple or all features and/or characteristics for a given part 26 may alternatively be utilized. Preferably, the predetermined margin is made on a percentage basis, however, absolute margins may be utilized. In exemplary embodiments, without limitation, the predetermined margins is/are set in the 3D part file data, such as acceptable tolerances for the part. However, in other exemplary embodiments, without limitation, the predetermined margin(s) is/are set by user preference, by default, combinations thereof, or the like.

Such analysis may be made by way of machine vision software, which may optionally utilize one or more artificial intelligence (“AI”) models, such as but not limited to, neural networks. For example, without limitation, the one or more servers 16 may comprise the machine vision software and/or AI model(s). The AI model(s), in exemplary embodiments, are trained using image data (e.g., from camera 18 images and/or X-ray 19 images) identified as being associated with sufficiently excavated/cleaned and non-sufficiently excavated/cleaned parts 26 and associated 3D files for such parts 26. Such images and/or image data may be manually tagged. The AI model(s) may optionally be updated over time, such as based on manually provided feedback regarding sufficiently and/or insufficiently excavated/cleaned parts 26. Such feedback may, for example and without limitation, be provided by technicians 20, supervisors, or the like, such as by way of associated electronic devices, by way of inventory control systems (e.g., based on customer rejections and/or returns), combinations thereof, or the like. The AI model(s) may be configured to utilize such feedback data to adjust the AI model(s) over time, such as part of training or retraining, thereby improving accuracy of results.

The analysis shown and/or described herein may optionally be completed using a digital twin of the parts 26, the build box 14, and/or manufacturing processes. The area(s) 28 for further excavation/cleaning may optionally be indicated in the digital twin.

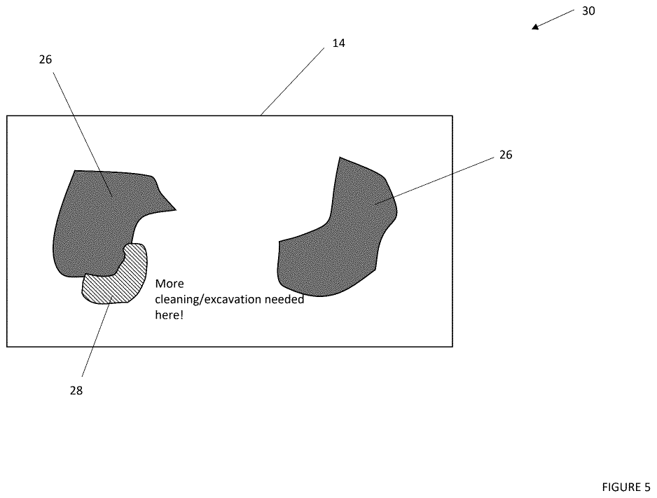

An exemplary output 30, by way of non-limiting example, is provided at FIG. 5. The output display 30 may be provided as a visual overlay at the AR device 22 and/or the projection device(s) 24 as an overlay at the build box 14. Alternatively, or additionally, such visual indications may be provided at one or more electronic displays 21 (e.g., TVs, display screens, smartphones, smartwatches, tablets, personal computers, laptops, combinations thereof, or the like), such as provided at the work area. The AR devices 22, projection device(s) 24, and/or electronic displays 21 may herein be sometimes referred to generally as visualization devices. Area(s) 28 for further excavation/cleaning may be indicated, such as by images, text, highlighting, texturing, outlining, color coding, pattern coding, combinations thereof, or the like at the visualization device(s). In this way, remaining build material, such as loose sand and/or support material, may be identified.

The electronic display(s) 21 may be configured to display a representation of the build box 14 with the area(s) 28 indicated at the representation, for example. The projection device(s) 24 may project the area(s) 28 directly on the build box 14, such as using projection mapping. The AR device(s) 22 may indicate the area(s) 28 when a wearer, such as the technician 20, is viewing the build box 14, such as based on the location of the build box 14, which may be identified by way of, for example and without limitation, machine vision (e.g., from imaging devices), a location device or other sensor embedded into the build box 14, combinations thereof, or the like.

Alternatively, or additionally, the server(s) 16 may be configured to cause the AR device 22 and/or projection device 24 to indicate the part(s) 26 as ideally formed in accordance with the 3D build files for display at the AR device 22 and/or overlay by way of the projection device(s) 24. Indication may include images, text, highlighting, outlining, color coding, combinations thereof, or the like. In this way, the technician 20 may be able to manually spot areas for further cleaning and/or excavation.

Where the server(s) 16 determines that the image data indicates that the part(s) 26 are within at least the predetermined margin(s) (e.g., 5% or less, 1% or less, etc.), such as for all features of the part(s) 26 of the build box 14, such as (but not limited to) in accordance with the margins specified in the part file, indication of a successfully excavated and/or cleaned part may be displayed at the AR device 22 and/or by way of the projection device(s) 24, and/or recorded, such as at the server(s) 16.

Where the server(s) 16 determines that the image data indicates that one or more of the part(s) 26 characteristics are not within at least the predetermined margin(s), such as (but not limited to) in accordance with the margins specified in the part file, the indications or the area(s) of attention (those not within the respective margin) may be identified at the AR device 22, by way of the projection device(s) 24, at the electronic display(s) 21, and/or otherwise recorded, such as at the server(s) 16. The technician 20 may perform further cleaning and/or excavation and then have the build box 14 and/or part(s) 26 thereof reinspected until an indication of successful cleaning/excavation is recorded.

This data may be traceable to the part(s) 26, build boxes 14, machines 12, and/or technicians 20, for example. Thereby providing an audit trail, certification, and/or history for generated parts 26.

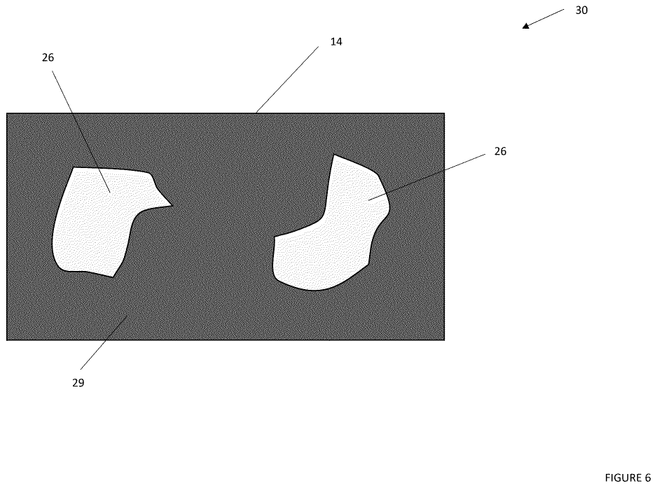

Alternatively, or additionally, as illustrated with particular regard to FIG. 6, the server(s) 16 may be configured to cause the AR device 22 and/or projection device 24 to indicate the support material 29 for the parts 26. In this way, the areas for excavation may be identified. In this way, the parts 26 may be relatively identified by inference (e.g., the areas not indicated as support material 29).

The parts 26, support material 29, and/or other areas for further cleaning/excavation may be identified using contrasting colors, textures, patterns, combinations thereof, or the like. A visual key or other identifier may be provided.

This may be provided for initial cleaning/excavation, further cleaning/excavation, and the like.

In an exemplary embodiments, without limitation, the systems and methods shown and/or described herein may be utilized in conjunction with a compensation tracking, visualization, and/or disbursement system, such as shown and/or described in U.S. Pat. No. 11,138,543 issued Oct. 5, 2021, the disclosures of which are hereby incorporated by reference as if fully restated herein, for any purpose. By way of non-limiting example, a part 26, manufacturing run, and/or other unit of production may be recorded as being successfully completed only were the image data indicates that the extracted feature characteristics of the part(s) 26 are within the associated predetermined margins of the associated feature characteristics as expected (e.g., indicated and/or extracted from 3D part/print file), such as for all characteristics, features, and/or parts of the respective unit of production. This may be particularly advantageous when utilized with regard to pay-per-part compensation schemes and related systems, methods, and/or devices, such as by not limited as provided in the '543 Patent, in order to ensure quality while maintaining incentives towards efficient production.

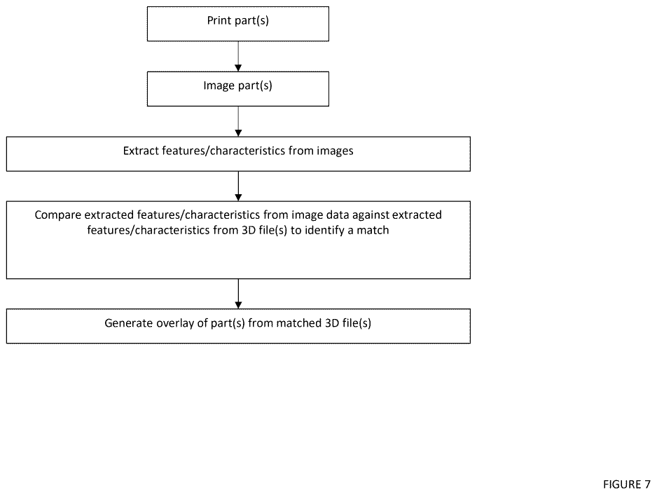

As illustrated with particular regard to FIG. 7, in exemplary embodiments, the part(s) 26 of the build box 14 may be matched with a corresponding part file, such as using the image data from the imaging devices (e.g., camera(s) 18, AR devices 22, and/or X-ray machines 19). The image data may be analyzed, such as using machine vision and/or feature extraction techniques (e.g., holes, shapes, outlines, surface features, combinations thereof, and the like), to identify features of the part(s) 26 and/or their locations. The extracted features information may be utilized to identify the part(s) 26. For example, without limitation, corresponding features information may be provided in 3D part files and/or extracted form the same. 3D part files describing parts at least within a predetermined tolerance (e.g., 5%) of the extracted features may be identified as a match. Completion of the corresponding part(s) 26 may be recorded. The corresponding part file data may thereafter be used to generate the overlay of the printed parts 26 and/or support material at the AR device 22, projection device(s) 24, and/or at electronic display(s) 21. In this way, an overlay of the printed part(s) 26 may be generated so that the team member can visualize and/or clean and/or excavate the part(s) 26. These overlays may be generated in alternative to, or in addition to, the overlays regarding areas needing further cleaning and/or excavation, for example. Some or all of the foregoing analysis and/or operations may be carried by out the server(s) 16, in exemplary embodiment.

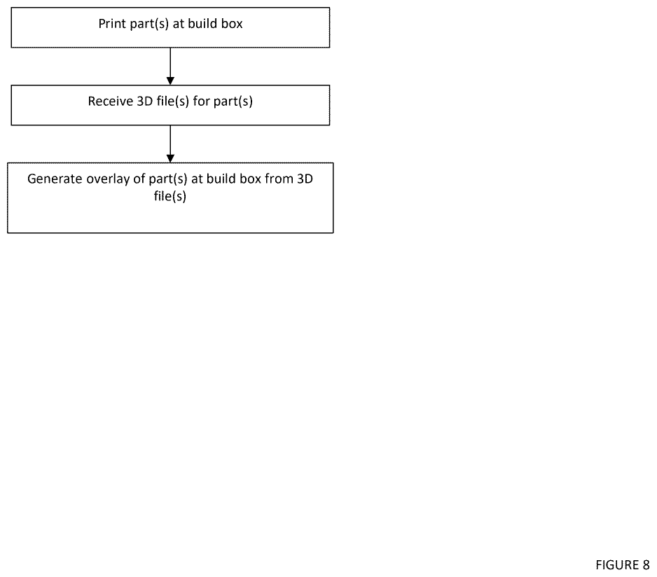

As illustrated with particular regard to FIG. 8, in exemplary embodiments, the 3D file(s) of the part(s) 26 of the build box 14 are provided, such as from the machine 12 and/or server(s) 16 based on operational data (e.g., what parts 26 are, or were most recently, printed by the machine 12). An overlay of the part(s) 26 is thereafter generated at the AR device 22, projection device(s) 24, and/or at electronic display(s) 21. In this way, an overlay of the printed part(s) 26 may be generated so that the team member can visualize and/or clean and/or excavate the part(s) 26. These overlays may be generated in alternative to, or in addition to, the overlays regarding areas needing further cleaning and/or excavation, for example. Some or all of the foregoing analysis and/or operations may be carried by out the server(s) 16, in exemplary embodiment.

In an exemplary embodiment, without limitation, a system for generating an overlay of parts at a build box generated by an additive manufacturing machine is provided, where said system comprises one or more non-transitory electronic storage devices comprising software instructions, which when executed, configure one or more processors to: receive 3D part files for the parts generated at the build box by the additive manufacturing machine; and cause an overlay of the parts to be generated at an augmented reality device or at the build box by a projection device.

Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention.

Certain operations described herein may be performed by one or more electronic devices. Each electronic device may comprise one or more processors, electronic storage devices, executable software instructions, combinations thereof, and the like configured to perform the operations described herein. The features and/or functionality shown and/or described herein may be accomplished by way of stored, executable software instructions, such as in the form of applications, programs, routines, combinations thereof, or the like. The electronic devices may be general purpose computers or specialized computing devices. The electronic devices may comprise personal computers, smartphones, tablets, databases, servers, or the like. The electronic connections and transmissions described herein may be accomplished by one or more wired or wireless connectivity components (e.g., routers, modems, ethernet cables, fiber optic cable, telephone cables, signal repeaters, and the like) and/or networks (e.g., internets, intranets, cellular networks, the world wide web, local area networks, and the like). The computerized hardware, software, components, systems, steps, methods, and/or processes described herein may serve to improve the speed of the computerized hardware, software, systems, steps, methods, and/or processes described herein. The electronic devices, including but not necessarily limited to the electronic storage devices, databases, controllers, or the like, may comprise and/or be configured to hold, solely non-transitory signals.

What is claimed is:

1. A system for indicating remaining build material for excavation and/or cleaning of
parts generated by additive manufacturing, said system comprising one or more non-transitory electronic storage devices comprising software instructions, which when executed, configure one or more processors to:
receive image data of one or more parts generated by an additive manufacturing machine;
analyze the image data to extract feature characteristics of the one or more parts on a part specific basis;
determine, on a feature characteristic specific basis, if the extracted feature characteristics are within predetermined margins of expected feature characteristics for the one or more parts; and
where one or more the extracted feature characteristics are not within the predetermined margins of the expected feature characteristics, cause corresponding areas to be visually indicated as needing further cleaning/excavation.

2. The system of claim 1 wherein:
the areas for further cleaning/excavation are visually indicated at a build box with the one or more parts by way of one or more projection devices.

3. The system of claim 1 wherein:
the areas for further cleaning/excavation are visually indicated at an augmented reality (“AR”) device associated with a technician for the additive manufacturing machine when viewing a build box with the one or more parts.

4. The system of claim 1 wherein:
the areas for further cleaning/excavation are visually indicated at one or more electronic displays at a work area for the additive manufacturing machine at a representation of a build box for the one or more parts.

5. The system of claim 1 wherein:
the image data is received from one or more cameras.

6. The system of claim 5 wherein:
the one or more cameras comprise a plurality of cameras.

7. The system of claim 1 wherein:
the image data is received from an x-ray machine.

8. The system of claim 1 wherein:
the expected feature characteristics and the predetermined margins are determined from one or more 3D files for the one or more parts.

9. The system of claim 8 wherein:
the expected feature characteristics and the predetermined margins are specified within the one or more 3D files.

10. The system of claim 8 wherein:
the expected feature characteristics are extracted from the one or more 3D files; and
the predetermined margins are selected by user preference or default settings.

11. The system of claim 8 wherein:
the predetermined margins are part, feature, and characteristic specific.

12. The system of claim 11 wherein:
the characteristics comprise location, size, and shape.

13. The system of claim 1 wherein:
the one or more non-transitory electronic storage devices comprise additional software instructions, which when executed, configure the one or more processors to:
visually indicate areas of support material at the build box.

14. The system of claim 1 wherein:
the additive manufacturing machine comprises a binder jetting machine.

15. The system of claim 1 wherein:
the one or more non-transitory electronic storage devices and the one or more processors are part of one or more servers.

16. The system of claim 1 further comprising:
a visualization device for providing the visual indication;
an imaging device for providing the image data; and
the additive manufacturing machine.

17. The system of claim 16 wherein:
the visualization device comprises a projection device, and the visual indication comprises projection mapping at a build box for the one or more parts;
the imaging device comprises an x-ray machine; and
the additive manufacturing machine comprises a binder jetting machine.

18. A system for indicating remaining build material for excavation and/or cleaning of
parts generated by additive manufacturing, said system comprising a projection device;
an x-ray machine;
a binder jetting machine; and
one or more servers comprising software instructions, which when executed, configure the one or more servers to:
receive 3D print files for parts generated by the binder jetting machine at build boxes, said 3D print files providing features for each of the parts, expected characteristics associated with each of the features, and predetermined margins associated with each of the characteristics such that the predetermined margins are characteristic specific, the characteristics are feature specific, and the features are part specific, said characteristics comprising location, size, and shape;
receive image data from the x-ray machine of the parts at the build boxes;
analyze the image data to extract features and characteristics of the parts;
determine if the extracted characteristics are within the predetermined margins of the expected characteristics on a feature and part specific basis; and
where any of the extracted characteristics are not within the associated predetermined margin of the associated expected characteristics, cause the projection device to visually indicate, at the build boxes, areas of the build boxes corresponding to the extracted features associated with the extracted characteristics not within the associated predetermined margin of the associated expected characteristics as needing further cleaning/excavation.

19. A system for indicating remaining build material for excavation and/or cleaning of
parts generated by additive manufacturing, said system comprising
an imaging device;
a visualization device;
a binder jetting machine; and
one or more servers comprising software instructions, which when executed, configure the one or more servers to:
receive a 3D print file for a part generated by the binder jetting machine at a build box, said 3D print file providing features for the part, expected characteristics associated with each of the features, and predetermined margins associated with each of the characteristics;
receive image data from the imaging device of the part at the build box generated by the binder jetting machine, and analyze the image data to extract feature characteristics of the part;
determine if the extracted characteristics are within the predetermined margins of the expected characteristics on a feature specific basis; and
where one or more of the extracted feature characteristics are not within the associated predetermined margin of the associated expected characteristics, cause the visualization device to visually indicate, at the build box, areas as needing further cleaning/excavation corresponding to the extracted features associated with the extracted characteristics not within the associated predetermined margin of the associated expected characteristics.
